(19) United States
(12) Patent Application Publication
(10) Pub. No.: US 2023/0020033 A1
(43) Pub. Date: Jan. 19, 2023

(54) AUTONOMOUS MACHINE NAVIGATION IN VARIOUS LIGHTING ENVIRONMENTS

(71) Applicant: THE TORO COMPANY, Bloomington, MN (US)

(72) Inventors: Alexander Steven Frick, Farmington, MN (US); Gregory S. Janey, Excelsior, MN (US)

(21) Appl. No.: 17/778,764

(22) PCT Filed: Nov. 2, 2020
(86) PCT No.: PCT/US2020/058501

§ 371 Date: May 20, 2022

Related U.S. Application Data
(60) Provisional application No. 62/941,434, filed on Nov. 27, 2019.

(51) Int. Cl. G05D 1/02; G01C 21/00; A01D 34/00

(52) U.S. Cl. CPC G05D 1/0246; G05D 1/0214; G05D 1/0278; G05D 1/0274; G01C 21/3807; A01D 34/008; G05D 2201/0208; A01D 2101/00

(57) ABSTRACT

Training an autonomous machine in a work region for navigation in various lighting conditions includes determining a feature detection range based on an environmental lighting parameter, determining a feature detection score for each of one or more positions in the containment zone based on the feature detection range, determining one or more localizable positions in the containment zone based on the corresponding feature detection scores, and updating the navigation map to include a localization region within the containment zone based on the one or more localizable positions. Navigation may use one or more of an uncertainty area, the localization region, and one or more buffer zones to navigate based on lighting conditions.

The present application claims priority to and/or the benefit of U.S. Provisional Patent Application No. 62/941,434, filed 27 Nov. 2019, which is incorporated herein by reference in its entirety.

The present disclosure generally relates to autonomous machine navigation and, in particular, autonomous machine navigation in various lighting environments.

Various machines, such as ground maintenance machine for lawns and gardens, may perform a variety of tasks. For example, powered lawn mowers may be used by both homeowners and professionals alike to maintain grass areas within a property or yard. Some lawn mowers have the capability to autonomously perform grass cutting within a predefined boundary or work region.

### SUMMARY

The techniques of this disclosure generally relate to providing autonomous machine functionality for navigation. Such functionality may facilitate autonomous machine operation in a wider range of times of day than some existing systems. In particular, autonomous machines using vision-based navigation may benefit from techniques to navigate in various light conditions, particularly outdoors which may experience daytime, nighttime, transitions between the two, and the effects of artificial lighting. Also, such functionality may provide for more flexible maintenance schedules for users to properly maintain work regions using autonomous machines, which may facilitate more consistent maintenance of work regions.

In one embodiment, the present disclosure provides a method of training an autonomous machine in a work region for navigation in various lighting conditions. The method includes determining data representing a navigation map of the work region. The navigation map includes a containment zone. The method also includes determining a feature detection range based on an environmental lighting parameter. The method also includes determining a feature detection score for each of one or more positions in the containment zone based on the feature detection range. The method also includes determining one or more localizable positions in the containment zone based on the corresponding feature detection scores. The method also includes updating the navigation map to include a localization region within the containment zone based on the one or more localizable positions and storing data representing the updated navigation map.

In another embodiment, the present disclosure provides a method of navigation in various lighting conditions for an autonomous machine in a work region. The method includes determining a localization region in a navigation map of the work region. The localization region is defined based on an environmental lighting parameter. The method also includes determining an operating mode based on the environmental lighting parameter. The method also includes directing the machine to operate autonomously within the localization region based on the operating mode.

In another embodiment, the present disclosure provides a method of navigation in various lighting conditions for an autonomous machine in a work region. The method includes directing the machine to operate autonomously within a containment zone defined in a navigation map of the work region. The method also includes determining whether vision-based localization is available at a position of the machine based on at least an environmental lighting parameter. The method also includes, in response to determining that vision-based localization is not available at the position of the machine, stopping autonomous movement of the machine until the machine is able to localize at the current position.

In yet another embodiment, the present disclosure provides an autonomous machine including a housing coupled to a maintenance implement, a propulsion system comprising a propulsion controller operably coupled to at least one motor, at least one camera adapted to record images in one or more environmental lighting conditions, and a controller operably coupled to the at least one camera and the propulsion controller. The controller is adapted to perform a method according to the present disclosure.

The summary is not intended to describe each embodiment or every implementation of the present disclosure. A more complete understanding will become apparent and appreciated by reference to the following detailed description and claims taken in view of the accompanying figures of the drawing.

### BRIEF DESCRIPTION OF THE DRAWINGS

Illustrative embodiments will be further described with reference to the figures of the drawings, wherein:

FIG. 1 is a conceptual diagram that illustrates one example of an autonomous machine.

FIG. 2 is a conceptual diagram that illustrates example systems of the autonomous machine of FIG. 1.

FIG. 3 is a conceptual diagram that illustrates one example of a work region in which the autonomous machine of FIG. 1 may operate.

FIG. 4 is a plot that illustrates one example of the size of an uncertainty area of the autonomous machine of FIG. 1 over time.

FIG. 5 is flow diagram that illustrates one example of a method of generating a navigation map including localization regions and buffer zones usable with the autonomous machine of FIG. 1.

FIG. 6 is a flow diagram showing one example of a method of navigating within localization regions usable with the autonomous machine of FIG. 1.

FIG. 7 is a flow diagram showing one example of a method of navigating within a containment zone using localization zones and buffer zones usable with the autonomous machine of FIG. 1.

FIG. 8 is a flow diagram showing one example of a method of navigating within a containment zone using buffer zones usable with the autonomous machine of FIG. 1.

The figures are rendered primarily for clarity and, as a result, are not necessarily drawn to scale. Moreover, various structure/components, including but not limited to fasteners, electrical components (wiring, cables, etc.), and the like, may be shown diagrammatically or removed from some or all of the views to better illustrate aspects of the depicted embodiments, or where inclusion of such structure/components is not necessary to an understanding of the various illustrative embodiments described herein. The lack of illustration/description of such structure/components in a particular figure is, however, not to be interpreted as limiting the scope of the various embodiments in any way.

### DETAILED DESCRIPTION

In the following detailed description of illustrative embodiments, reference is made to the accompanying figures of the drawing which form a part hereof. It is to be understood that other embodiments, which may not be described and/or illustrated herein, are certainly contemplated.

All headings provided herein are for the convenience of the reader and should not be used to limit the meaning of any text that follows the heading, unless so specified. Moreover, unless otherwise indicated, all numbers expressing quantities, and all terms expressing direction/orientation (e.g., vertical, horizontal, parallel, perpendicular, etc.) in the specification and claims are to be understood as being modified in all instances by the term “exactly” or “about.” The term “or” is generally employed in its inclusive sense, for example, to mean “and/or” unless the context clearly dictates otherwise. The term “and/or” (if used) means one or all of the listed elements or a combination of any two or more of the listed elements. The term “i.e.” is used as an abbreviation for the Latin phrase id est and means “that is.” The term “e.g.,” is used as an abbreviation for the Latin phrase exempli gratia and means “for example.”

Embodiments of this disclosure generally relate to providing autonomous machine functionality for navigation. Such functionality may facilitate autonomous machine operation in a wider range of times of day than some existing systems. In particular, autonomous machines using vision-based navigation may benefit from techniques to navigate in various light conditions, particularly outdoors which may experience daytime, nighttime, transitions between the two, and the effects of artificial lighting. Also, such functionality may provide for more flexible maintenance schedules for users to properly maintain work regions using autonomous machines, which may facilitate more consistent maintenance of work regions.

As used herein, the term “daytime” refers to a range of times between dawn and twilight. The term “daylight” refers to a range of lighting conditions associated with daytime.

While described herein in illustrative examples as an autonomous mower, such a configuration is only illustrative, as systems and methods described herein also have application to other autonomous machines including, for example, commercial mowing products, other ground working machines or vehicles (e.g., debris blowers/vacuums, aerators, dethatchers, material spreaders, snow throwers, weeding machines for weed remediation), indoor working vehicles such as vacuums and floor scrubbers/cleaners (e.g., that may encounter obstacles), construction and utility vehicles (e.g., trenchers), observation vehicles, and load transportation (e.g., including people and things, such as people movers and hauling equipment). Furthermore, the autonomous machines described herein may employ various one or more types of navigation, such as random, modified random, or specific path planning, to carry out their intended functionality.

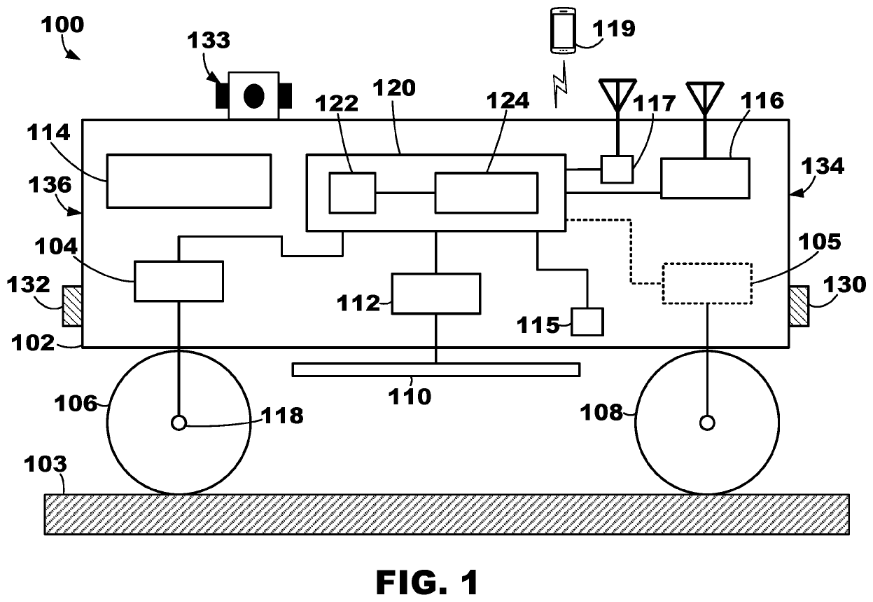

It is noted that the terms “have,” “include,” “comprises,” and variations thereof, do not have a limiting meaning, and are used in their open-ended sense to generally mean “including, but not limited to,” where the terms appear in the accompanying description and claims. Further, “a,” “an,” “the,” “at least one,” and “one or more” are used interchangeably herein. Moreover, relative terms such as “left,” “right,” “front,” “fore,” “forward,” “rear,” “aft,” “rearward,” “top,” “bottom,” “side,” “upper,” “lower,” “above,” “below,” “horizontal,” “vertical,” and the like may be used herein and, if so, are from the perspective shown in the particular figure, or while the machine 100 is in an operating configuration (e.g., while the machine 100 is positioned such that wheels 106 and 108 rest upon a generally horizontal ground surface 103 as shown in FIG. 1). These terms are used only to simplify the description, however, and not to limit the interpretation of any embodiment described.

The techniques of this disclosure may be used with any suitable autonomous machine. FIG. 1 illustrates one example of an autonomous grounds maintenance machine (e.g., an autonomously operating vehicle, such as an autonomous lawn mower 100) of a lawn mowing system (for simplicity of description, the mower 100 is illustrated schematically). The mower 100 may include functionality to navigate autonomously in various lighting conditions, such as in daylight or at night.

As shown in this view, the mower 100 may include a housing 102 (e.g., frame or chassis with a shroud) that carries and/or encloses various components of the mower as described below. The mower 100 may further include ground support members, such as wheels, rollers, or tracks. In the illustrated embodiment, ground support members shown includes one or more rear wheels 106 and one or more front wheels 108, that support the housing 102 upon a ground (grass) surface 103. As illustrated, the front wheels 108 are used to support a front-end portion 134 of the mower housing 102 and the rear wheels 106 are used to support the rear end portion 136 of the mower housing.

One or both rear wheels 106 may be driven by a propulsion system (e.g., including one or more electric wheel motors 104) to propel the mower 100 over the ground surface 103. In some embodiments, the front wheels 108 may freely caster relative to the housing 102 (e.g., about vertical axes). In such a configuration, mower direction may be controlled via differential rotation of the two rear wheels 106 in a manner similar to some existing zero-turn-radius (ZTR) riding mowers. That is to say, the propulsion system may include a separate wheel motor 104 for each of a left and right rear wheel 106 so that speed and direction of each rear wheel may be independently controlled. In addition, or alternatively, the front wheels 108 could be actively steerable by the propulsion system (e.g., including one or more steer motors 105) to assist with control of mower 100 direction, and/or could be driven by the propulsion system (i.e., to provide a front-wheel or all-wheel drive mower).

An implement (e.g., a grass cutting element, such as a blade 110) may be coupled to a cutting motor 112 (e.g., implement motor) carried by the housing 102. When the motors 112 and 104 are energized, the mower 100 may be propelled over the ground surface 103 such that vegetation (e.g., grass) over which the mower passes is cut by the blade 110. While illustrated herein using only a single blade 110 and/or motor 112, mowers incorporating multiple blades, powered by single or multiple motors, are contemplated within the scope of this disclosure. Moreover, while described herein in the context of one or more conventional “blades,” other cutting elements including, for example, disks, nylon string or line elements, knives, cutting reels, etc., are certainly possible without departing from the scope of this disclosure. Still further, embodiments combining various cutting elements, e.g., a rotary blade with an edge-mounted string trimmer, are also contemplated.

The mower 100 may further include a power source, which in one embodiment, is a battery 114 having a lithium-based chemistry (e.g., lithium-ion). Other embodiments may utilize batteries of other chemistries, or other power source technologies (e.g., solar power, fuel cell, internal combustion engines) altogether, without departing from the scope of this disclosure. It is further noted that, while shown as using independent blade and wheel motors, such a configuration is illustrative only as embodiments wherein blade and wheel power is provided by a single motor are also contemplated.

The mower 100 may further include one or more sensors to provide location data. For instance, some embodiments may include a global positioning system (GPS) receiver 116 (or other position sensor that may provide similar data) that is adapted to estimate a position of the mower 100 within a work region and provide such information to a controller 120 (described below). In other embodiments, one or more of the wheels 106, 108 may include encoders 118 that provide wheel rotation/speed information that may be used to estimate mower position (e.g., based upon an initial start position) within a given work region. The mower 100 may also include a sensor 115 adapted to detect a boundary wire, which could be used in addition to other navigational techniques described herein.

The mower 100 may include one or more front obstacle detection sensors 130 and one or more rear obstacle detection sensors 132, as well as other sensors, such as side obstacle detection sensors (not shown). The obstacle detection sensors 130, 132 may be used to detect an obstacle in the path of the mower 100 when traveling in a forward or reverse direction, respectively. The mower 100 may be capable of mowing while moving in either direction. As illustrated, the sensors 130, 132 may be located at the front-end portion 134 or rear end portion 136 of the mower 100, respectively.

The sensors 130, 132 may use contact sensing, non-contact sensing, or both types of sensing. For example, both contact and non-contact sensing may be enabled concurrently or only one type of sensing may be used depending on the status of the mower 100 (e.g., within a zone or traveling between zones). One example of contact sensing includes using a contact bumper protruding from the housing 102, or the housing itself, that can detect when the mower 100 has contacted the obstacle. Non-contact sensors may use acoustic or light waves to detect the obstacle, sometimes at a distance from the mower 100 before contact with the obstacle (e.g., using infrared, radio detection and ranging (radar), light detection and ranging (lidar), etc.).

The mower 100 may include one or more vision-based sensors to provide localization data, such as position, orientation, or velocity. The vision-based sensors may include one or more cameras 133 that capture or record images for use with a vision system. The cameras 133 may be described as part of the vision system of the mower 100. Types of images include, for example, training images and/or operational images.

The one or more cameras 133 may be used to determine an environmental lighting parameter based on an exposure time. The one or more cameras 133 may vary exposure time until a sufficient, or good, image is captured. The environmental lighting parameter may be determined based on the exposure time corresponding to the good image. The environmental lighting parameter may be based on an average of exposure times taken by different cameras 133, taken at different times using the one or more cameras, or both.

Additionally, or alternatively, the one or more cameras 133 may include a light meter or may be supplemented by a separate light meter. Cameras and light meters may be used to determine an environmental lighting parameter indicative of a light level of the environment, which may be measured in Lux, around the mower 100. The environmental lighting parameter may be based on an average from one or more cameras or light meters.

In some embodiments, the environmental lighting parameter may be a predetermined or nominal value. For example, the environmental lighting parameter may be a factory setting that represents a nominal or worst-case lighting condition.

The environmental lighting parameter may also be determined based on a time of day. The relationship between environmental lighting parameter and the time of day may be based on a factory setting or calibrated based on exposure time or other lighting measurements.

The one or more cameras 133 may be capable of detecting visible light, non-visible light (e.g., infrared light), or both. Any suitable total field of view may be used. In some embodiments, the one or more cameras 133 may establish a total field of view relative to a horizontal plane greater than or equal to 30, 45, 60, 90, 120, 180, 270, or 360 degrees, around the autonomous machine (e.g., mower 100). In some embodiments, one or more cameras 133 may establish a total field of view, for example, relative to a horizontal plane less than or equal to 360, 270, 180, 120, 90, 60, 45, or 30 degrees around the autonomous machine. The field of view may be defined in a horizontal direction, a vertical direction, or both directions. For example, a total horizontal field of view may be less than or equal to 360 degrees, and a total vertical field of view may be 45 degrees. In some embodiments, the total field of view may be described in a three-dimensional (3D) geometry, such as steradians. For example, the total field of view may be less than or equal to 4π steradians. The field of view may capture image data above and below the height of the one or more cameras 133.

In some embodiments, the mower 100 includes four cameras 133. One camera 133 may be positioned in each of one or more of directions including a forward direction, a reverse direction, a first side direction, and a second side direction (e.g., Cardinal directions relative to the mower 100). One or more camera directions may be positioned orthogonal to one or more other cameras 133 or positioned opposite to at least one other camera 133. The cameras 133 may also be offset from any of these directions (e.g., at a 45 degree or another non-right angle).

The mower 100 may be guided along a path, for example, in a manual manner using a handle. In particular, manual direction of the mower 100 may be used during a training mode to learn a work region or a boundary associated with the work region.

The camera 133 positioned in a forward direction may have a position and orientation that represents a pose of the autonomous machine. In some embodiments, the position and orientation of the cameras may be defined relative to a geometric center of the mower 100 or relative to one of the edges of the mower 100.

As used herein, the term “pose” refers to a position and an orientation. The pose may be a six-degrees of freedom pose (6DOF pose), which may include all position and orientation parameters for a three-dimensional space. Pose data may include a three-dimensional position and a three-dimensional orientation. For example, the position may include at least one position parameter selected from: an x-axis, a y-axis, and a z-axis coordinate (e.g., using a Cartesian coordinate system). Any suitable angular orientation representations may be used. Non-limiting examples of angular orientation representations include a yaw, pitch, and roll representation, a Rodrigues' representation, a quaternions representation, and a direction cosine matrix (DCM) representation may also be used alone or in combination. In one example, the orientation may include at least one orientation parameter selected from a yaw (e.g., vertical z-axis orientation), a pitch (e.g., a transverse y-axis orientation), and a roll (e.g., a longitudinal x-axis orientation).

Sensors of the mower 100 may also be described as either vision-based sensors and non-vision-based sensors. Vision-based sensors may include cameras 133 that are capable of recording images. The images may be processed and used to build a three-dimensional (3D) point cloud or used for optical odometry (e.g., optical encoding). Non-vision-based sensors may include any sensors that are not cameras 133. For example, a wheel encoder that uses optical (e.g., photodiode), magnetic, or capacitive sensing to detect wheel revolutions may be described as a non-vision-based sensor that does not utilize a camera. Wheel encoding data from a wheel encoder may be also described as odometry data.

Optical encoding may be used by taking a series or sequence of images and comparing features in the images to determine or estimate a distance traveled between the images. Optical encoding may be less susceptible to wheel slippage than a wheel encoder for determining distance or speed.

In addition to the sensors described above, other sensors now known or later developed may also be incorporated into the mower 100.

The mower 100 may also include a controller 120 adapted to monitor and control various mower functions. The controller 120 may include a processor 122 that receives various inputs and executes one or more computer programs or applications stored in memory 124. The memory 124 may include computer-readable instructions or applications that, when executed, e.g., by the processor 122, cause the controller 120 to perform various calculations and/or issue commands. That is to say, the processor 122 and memory 124 may together define a computing apparatus operable to process input data and generate the desired output to one or more components/devices. For example, the processor 122 may receive various input data including positional data from the GPS receiver 116 and/or encoders 118 and generate speed and steering angle commands to the drive wheel motor(s) 104 to cause the drive wheels 106 to rotate (at the same or different speeds and in the same or different directions). In other words, the controller 120 may control the steering angle and speed of the mower 100, as well as the speed and operation of the cutting blade.

Reference herein may be made to various parameters, data, or data structures, which may be handled in a controller 120, for example, by being processed by a processor 122 or stored in or retrieved from a memory 124.

The controller 120 may use the processor 122 and memory 124 in various different systems. In particular, one or more processors 122 and memory 124 may be included in each different system. In some embodiments, the controller 120 may at least partially define a vision system, which may include a processor 122 and memory 124. The controller 120 may also at least partially define a navigation system, which may include a processor 122 and memory 124 separate from the processor 122 and memory 124 of the vision system.

Each system may also be described as having its own controller 120. For example, the vision system may be described as including one controller 120 and the navigation system may be described as having another controller 120. As such, the mower 100 may be described as having multiple controllers 120. In general, as used herein, the term “controller” may be used to describe components of a “system” that provide commands to control various other components of the system.

In view of the above, it will be readily apparent that the functionality of the controller 120 may be implemented in any manner known to one skilled in the art. For instance, the memory 124 may include any volatile, non-volatile, magnetic, optical, and/or electrical media, such as a random-access memory (RAM), read-only memory (ROM), non-volatile RAM (NVRAM), electrically-erasable programmable ROM (EEPROM), flash memory, and/or any other digital media. While shown as both being incorporated into the controller 120, the memory 124, and the processor 122 could be contained in separate modules.

The processor 122 may include any one or more of a microprocessor, a controller, a digital signal processor (DSP), an application specific integrated circuit (ASIC), a field-programmable gate array (FPGA), and/or equivalent discrete or integrated logic circuitry. In some embodiments, the processor 122 may include multiple components, such as any combination of one or more microprocessors, one or more controllers, one or more DSPs, one or more ASICs, and/or one or more FPGAs, as well as other discrete or integrated logic circuitry. The functions attributed to the controller 120 and/or processor 122 herein may be embodied as software, firmware, hardware, or any combination of these. Certain functionality of the controller 120 may also be performed with Internet-connected cloud computing or other distributed computing systems operably connected to the processor 122.

In FIG. 1, schematic connections are generally shown between the controller 120 and the battery 114, wheel motor(s) 104, blade motor 112, optional boundary wire sensor 115, wireless radio 117, and GPS receiver 116. This interconnection is illustrative only as the various subsystems of the mower 100 could be connected in most any manner, e.g., directly to one another, wirelessly, via a bus architecture (e.g., controller area network (CAN) bus), or any other connection configuration that permits data and/or power to pass between the various components of the mower. Although connections with some of the sensors 130, 132, 133 are not shown, these sensors and other components of the mower 100 may be connected in a similar manner. The wireless radio 117 may communicate over a cellular or other wide area network (e.g., even over the internet), a local area network (e.g., IEEE 802.11 “Wi-Fi” radio), or a peer-to-peer (P2P) (e.g., BLUETOOTH™) network with a separate user interface device 119 (e.g., mobile device, such as a smartphone, tablet, desktop, or wearable computer). In turn, the user interface device 119 may communicate with other devices over similar networks and, for example, may be used to connect the mower 100 to the internet.

The user interface device 119 may or may not be couplable to the mower 100. In some embodiments, the user interface device 119 may be used to provide user input or commands from the user to the mower 100. In some embodiments, the user interface device 119 may be used to provide an indication to the user, such as a visual presentation on a graphical user interface (e.g., screen or touchscreen).

In some embodiments, various functionality of the controller or controllers 120 described herein may be offloaded from the mower 100. For example, recorded images may be transmitted to a remote server (e.g., in the cloud) using the wireless radio 117 and processed or stored. The images stored, or other data derived from processing, may be received using the wireless radio 117 and be stored on, or further processed by, the mower 100.

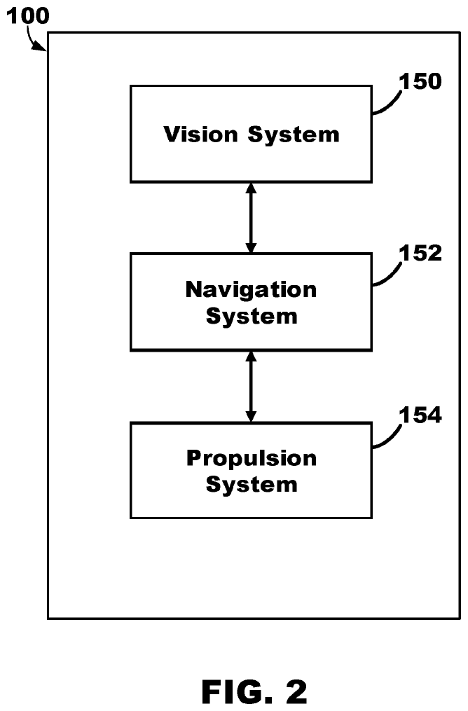

In general, the controller 120 and various components or systems of the mower 100 may be used to carry out various functionality described herein. Some examples of systems of the mower 100 are shown in FIG. 2.

FIG. 2 shows an overview of various systems of the mower 100 of FIG. 1 including a vision system 150, a navigation system 152, and a propulsion system 154. Although all systems 150, 152, 154 are shown as entirely part of the mower 100, in some embodiments, some or all of each system may also be located off the mower 100. The vision system 150 may be operably coupled to the navigation system 152, and the navigation system 152 may be operably coupled to the propulsion system 154. Any suitable navigation technique may be used with the mower 100. In some embodiments, navigation techniques may be used as described in U.S. patent application Ser. No. 16/534,515, filed Aug. 7, 2019, and U.S. Provisional Application No. 62/831,347, filed Apr. 9, 2019, which are incorporated by reference.

Sensors of the navigation system 152 may be used to record non-vision-based data during a training mode while the vision system 150 records images, such as training images. Although the mower 100 may be directed manually by a user, in some embodiments, the navigation system 152 may autonomously direct the machine during the training mode. The vision system 150 may include one or more cameras to record, or capture, images. In some embodiments, a controller of the vision system 150 may provide position and/or orientation data to the navigation system 152 based on the recorded images, which may be used to facilitate navigation of the mower 100. For example, the vision system 150 may provide an estimated position and/or orientation of the mower 100 to the navigation system 152 based on vision-based sensor data.

In some embodiments, the navigation system 152 may primarily use a position and/or orientation based on non-vision-based sensor data for navigation. For example, non-vision-based sensor data may be based on an output from an inertial measurement unit or wheel encoder. During a training mode or an offline mode, for example, a controller of the navigation system 152 may determine a boundary using non-vision-based sensor data, and the vision-based data, for subsequent navigation of the autonomous machine in the work region. During an online mode, for example, a controller of the navigation system 152 may determine a pose based on vision-based pose data, non-vision-based pose data, or both. In some embodiments, a pose may be determined based on non-vision-based sensor data and update the pose based on the vision-based pose data, which may be described as vision-based localization. The navigation system 152 may compare data from various sensors to correct for errors and update the position, which may be described as sensor fusion. For example, the vision-based position and/or orientation may be compared to the non-vision-based position and/or orientation. In some embodiments, sensor data other than vision-based sensor data may be used to correct for errors and update the position, such as GPS data.

The navigation system 152 may extract feature data from images captured by the vision system 150. Feature data may be extracted from training images to provide training feature data. Using training feature data, the navigation system 152 may generate a three-dimensional point cloud (3DPC) and associated data, which may include a plurality of 6DOF poses of the autonomous machine, to represent the work region. The 3DPC and poses may be registered in a navigation map. Optionally, non-vision-based data, such as GPS data, IMU data, and odometry data may also be registered to a real-world coordinate system, such as a coordinate system of an Earth-referenced map. Feature data may be extracted from operational images and compared with the training feature data, which may be described as feature matching. During operation, the comparison of operational feature data to training feature data may be used to identify a position and/or orientation of the autonomous machine to facilitate navigation.

As used herein, the term “feature” refers to two-dimensional (2D) data that results from identifying one or more points, in particular key points or points of interest, in a two-dimensional image. Features may be identified in and extracted from an image using a feature detector algorithm. Any suitable feature detector algorithm available to one having ordinary skill in the art may be used depending on the particular autonomous machine and application. In some embodiments, each unique feature refers to only one point, or point of interest, in an image or 3DPC. The feature may be stored as feature data containing coordinates defined relative to the image frame. In some embodiments, feature data may also include a descriptor applied to, associated with, or corresponding to the feature. The term “feature data” refers to a data structure that represents features and may include a two-dimensional position and a multi-dimensional descriptor (e.g., two-dimensional or three-dimensional).

Key points used to identify features may be extracted from various objects in an image. In some embodiments, the objects may be permanent, temporary, or both. In some embodiments, the objects may be natural, artificial, or both. One example of a permanent feature is a corner of a house. One example of a natural feature is an edge of a tree trunk. Some examples of temporary and artificial features include a stake in the ground and a target on a tree. The artificial feature may be temporarily placed and used to increase feature density within a work region (e.g., to improve a low-quality portion of a 3DPC). The artificial feature may be powered and, for example, may include a light emitter for visible or non-visible light detectable by a camera. The artificial feature may be unpowered and, for example, may include a visible or non-visible pattern detectable by a camera. Some artificial features may be permanently placed. As used herein, the term “non-visible” refers to emitting or reflecting wavelengths of light that are not visible to the human eye, but which may emit or reflect wavelengths visible by a camera, such as an infrared camera on the autonomous machine.

As used herein, the term “descriptor” refers to two-dimensional data that results from a descriptor algorithm. The descriptor describes the feature in the context of the image. In some embodiments, a descriptor may describe pixel values, image gradients, scale-space information, or other data in the image near or around the feature. For example, the descriptor may include an orientation vector for the feature or may include a patch of image. Any suitable descriptor algorithm for providing context for a feature in an image that is available to one having ordinary skill in the art may be used depending on the particular autonomous machine or application. A descriptor may be stored as part of feature data.

Any suitable technique may be used to extract features from images, which may include or utilize algorithms, such as a Scale Invariant Feature Transform (SIFT), Speeded Up Robust Features (SURF), Oriented FAST and Rotated Brief (ORB), KAZE, Accelerated-KAZE (AKAZE), linear feature tracking, camera merging, loop closure, incremental structure from motion, or other suitable algorithms. Such algorithms may, for example, provide one or more features and related descriptors.

Any suitable technique may be used for feature matching, which may include or utilize algorithms, such as Brute-Force, Approximate Nearest Neighbor (ANN), and Fast Library for Approximate Nearest Neighbor (FLANN). The Brute-Force algorithm may match features by selecting one feature and checking all other features for a match.

As used herein, the term “three-dimensional point cloud,” “3D point cloud,” or “3DPC” is a data structure that represents or contains three-dimensional geometric points which correspond to features extracted from images. The 3DPC may be associated with various properties, such as poses. In some embodiments, the geometric points and poses may or may not be defined in a coordinate system based on an arbitrary frame of reference. In some embodiments, the 3DPC may or may not be associated with a scale, orientation, or both that is tied to the real-world, for example, until a map registration process has been performed. The 3DPC may be generated based on feature matching data. A graph, or visual map, may be generated based on the 3DPC to provide a human-viewable representation of the 3DPC.

Any suitable technique may be used to generate the 3DPC, which may include or utilize algorithms, such as Structure from Motion (SfM) or Simultaneous Localization and Mapping (SLAM), either of which may be used with various embodiments of the present disclosure, for example, depending on the particular autonomous machine and application.

A controller of the navigation system 152 may command the propulsion system 154 based on an updated pose. For example, a corrected or updated position or orientation may be used by the navigation system 152 to provide propulsion commands to a propulsion system 154. The propulsion system 154 (e.g., propulsion hardware) may be defined to include, for example, motors 112, 104 and wheels 106, 108 (FIG. 1) or any related drivers (e.g., motor controllers or microchips).

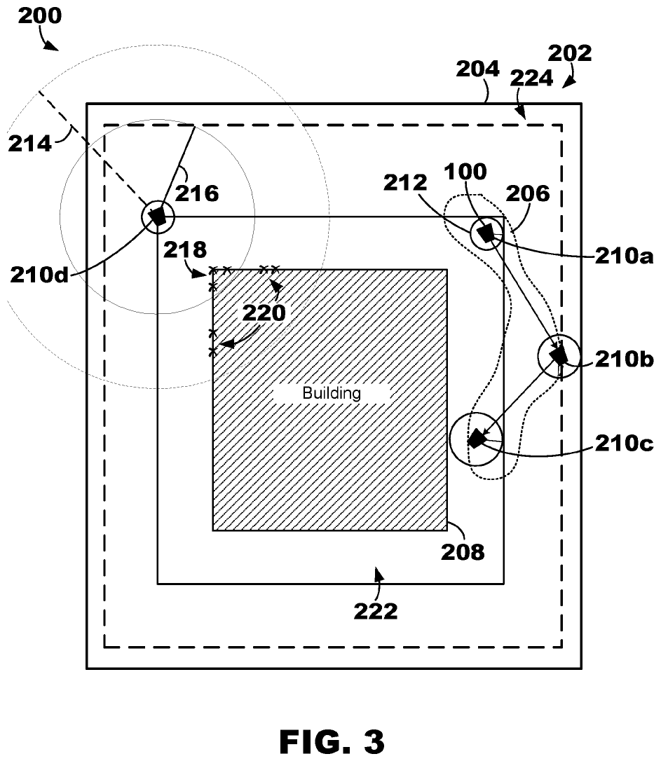

FIG. 3 shows an overhead conceptual diagram of some features of a navigation map 200 for a work region 202. The work region 202 may be described the area in which an autonomous machine, such as the mower 100, operates to perform certain tasks. For example, the work region 202 for the mower 100 may include a yard or other grassy area. The navigation map 200 may define certain navigational constructs relative to the work region 202, such as zones and boundaries. The navigation map 200 may be used, for example, by the navigation system 152 (FIG. 2) to facilitate navigation and by the user interface device 119 to show the user some or all of the navigation map and to receive user input related to the navigation map.

The navigation map 200 may define one or more zones and related boundaries for different purposes. In some embodiments, the navigation map 200 may define one or more containment zones, such as containment zones 204, 206, within the work region 202. Containment zones may be described as areas in which the mower 100 operates to perform a task. For example, the mower 100 may perform the task of mowing all grass in one containment zone. During operation, the mower 100 may be directed to travel within the boundary for a containment zone for a period of time, for example, without crossing or intersecting with the containment zone boundary.

In some embodiments, a containment zone may be described as a static containment zone, which does not change as the mower 100 operates, such as containment zone 204. In some embodiments, a containment zone may be described as a dynamic containment zone, which changes as the mower 100 operates, such as containment zone 206. One example of a dynamic containment zone is a travelling containment zone as described in U.S. Provisional Application No. 62/588,680 (Ingvalson et al.), filed Nov. 20, 2017, and U.S. Provisional Application No. 62/599,938 (Ingvalson et al.), filed Dec. 18, 2017, which are incorporated by reference. The travelling containment zone may be used to cover a trained containment zone 206.

In some embodiments, the navigation map 200 may define one or more exclusion zones and related boundaries, such as exclusion zone 208, within the work region 202. Exclusion zones may represent an area of the work region 202 for the mower 100 to avoid or travel around. For example, the exclusion zone 208 may contain an obstacle (such as a landscaped garden) or problem area (such as a steep slope). In the illustrated embodiment, the exclusion zone 208 contains a building, such as a house. Exclusion zones may be defined within a containment zone. During operation, the mower 100 may be directed to travel within the containment zone for a period of time, for example, without crossing or intersecting with the exclusion zone boundary.

In some embodiments (not shown), the navigation map 200 may define one or more transit zones, which may also be described as a transit path. In general, a transit zone is a zone or path connecting two other zones, such as connecting two different containment zones. A maintenance task may or may not be performed in the transit zone. For example, the mower 100 may not mow grass in a transit zone. In an example involving a yard divided by a driveway, a transit zone may include the entire driveway, or at least a path across the driveway, between two grassy parts of a lawn for the mower 100 to traverse.

In some embodiments, the position and/or orientation of the mower 100 may be estimated or determined based on non-vision-based sensor data. An uncertainty may be associated with the determined position and/or orientation. The uncertainty in the position and/or orientation may be represented by an uncertainty area 212 proximate to the mower 100. The uncertainty area 212 may correspond to an estimation or determination of where the mower 100 could be in the navigation map 200, for example, based on a probability. Although the uncertainty is shown and described as an area, any suitable parameter may be used indicate of the uncertainty area 212, such as one or more of an uncertainty radius or distance.

In the illustrated embodiment, the uncertainty area 212 is shown as a circle. A circle may represent a uniform radius around the mower 100, which may be used in simple cases as an estimate or when uncertainty is uniformly distributed around the mower. In some embodiments (not shown), the uncertainty area 212 may have a different shape and the mower 100 may not be located at the centroid of the uncertainty area. For example, the uncertainty area 212 may have an elliptical or ovate shape. The uncertainty area 212 may be determined using various sensors of the mower 100, which may be used to provide error corrections. The uncertainty area 212 may also be determined relative to the navigation map 200.

In some embodiments, the uncertainty area 212 may be determined based on the sensors of the mower 100 giving error corrections along with how the mower is moving. For example, if the mower 100 were measuring distance in a forward direction, the error in front of the mower may be small because of constant measurement. A side error may grow as the mower 100 moves, until the mower turns and measures a distance to the side to eliminate that error. The error may be described as position error relative to where the mower 100 is in the navigation map 200. In the case of turning to eliminate the error via movement, the error ellipse may not turn with the mower 100. The uncertainty area 212 may be defined based on the coordinates of the navigation map 200. Turning the mower 100 may allow error to drop along different axes of the navigation map 200.

Over time, as the mower 100 operates and traverses the work region 202, the accuracy of the determined position and/or orientation may become less certain, or more uncertain, which may also be described as drift. As a result, the calculated uncertainty area 212 may grow. In the illustrated embodiment, the mower 100 is shown traversing from a first position 210a to a second position 210b to a third position 210c. The uncertainty area 212 covers a first area at the first position 210a, a second area greater than the first area at the second position 210b, and a third area greater than the second area at the third position 210c.

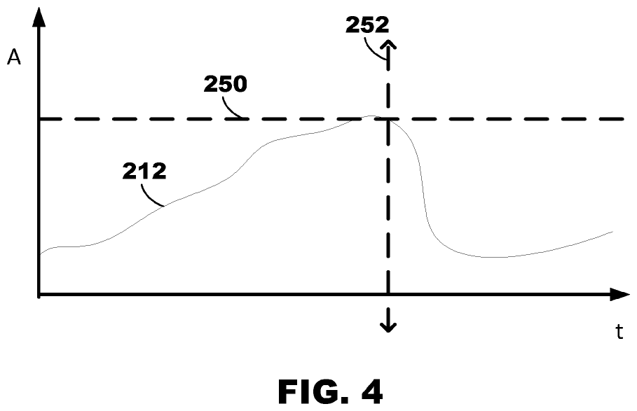

The pose may be updated using vision-based pose data to decrease the uncertainty area 212. The pose may be updated, for example, based on the uncertainty area 212 and an uncertainty area threshold. In particular, the uncertainty area 212 may be compared to the uncertainty area threshold. When the uncertainty area 212 exceeds the uncertainty area threshold, the mower 100 may initiate a vision-based localization process. As can be seen in FIG. 4, showing the uncertainty area 212 (A) along the y-axis growing over time (t) along the x-axis until meeting the uncertainty area threshold 250 at time 252. After time 252, the uncertainty area 212 may decrease significantly. The vision-based localization process may be described as using vision-based pose data, independently or in combination with other non-vision-based pose data, to determine and update the pose of the mower 100. The mower 100 may repeat this process whenever the uncertainty area 212 exceeds the uncertainty area threshold during operation.

In some embodiments, the uncertainty area 212 may not be completely reduced with every localization attempt. Some vision-based localizations may only reduce the uncertainty area 212 partially. In response, the mower 100 may initiate a next vision-based localization sooner or may initiate vision-based localizations more frequently.

The ability to use vision-based localization may depend on the visibility of the mower 100. For example, in the daylight, the mower 100 may be able to localize at a particular location but may not be able to localize at the same location in the night, when there is less environmental light available. The visibility of the mower 100 may be represented by a feature detection range. The feature detection range may be described as a maximum or target distance that the mower 100 is able to detect features, which may change based on environmental lighting. For example, in the daylight, the mower 100 may be described as having a first feature detection range 214, and in the night or in low lighting, the mower 100 may be described as having a second feature detection range 216, which is less than the first feature detection range. In the illustrated embodiment, features 218 are within the first feature detection range 214 and the second feature detection range 216 when the mower 100 is at a fourth position 210d. The features 220 are within the first feature detection range 214 but outside of the second feature detection range 216 when the mower 100 is at the fourth position 210d. Each feature 218, 210 is schematically illustrated with an “x”.

In general, a feature detection range, such as feature detection ranges 214, 216, may be determined based on an environmental lighting parameter indicative of a light level of the surrounding environment. In one example, one or more camera exposure times may be used to indicate the light level. In another example, one or more luminosity readings from one or more light meters may be used to indicate the light level. In some embodiments, the environmental lighting parameter may be based on a nighttime environmental lighting parameter. In one example, the nighttime environmental lighting parameter may correspond to a predetermined environmental lighting at night, which may be a nominal or default value that corresponds to a worst-case environmental lighting. In another example, the nighttime environmental lighting parameter may correspond to a measurement in the work region 202 at night, for example, using one or more camera exposure times. In some embodiments, the environmental lighting parameter may correspond to a measurement in the work region 202 during the day, for example, based on one or more camera exposure times during the day.

The mower 100 may be used to determine which positions and/or orientations within the work region 202 are localizable. Whether a particular position and/or orientation is localizable may depend on a feature detection score for the particular position and/or orientation. The feature detection score may be determined based on the quality of features, quantity of features, or both that can be extracted from images captured by the mower 100 at the particular position and/or orientation for a particular feature detection score. The particular position and/or orientation may be determined to be localizable if the feature detection score exceeds a minimum threshold. The minimum threshold may be determined based on, or may correspond to, a calculated probability that the mower 100 will be able to localize at the particular position and/or orientation, such as 50, 60, 70, 80, 90, 95, 99, or even 100 percent.

The feature detection score may be determined based on the quality of features, quantity or features, or both within the feature detection range. The particular position and/or orientation may be determined to be localizable in response to the number of features within the feature detection range exceeding a minimum features to localize (MFL) threshold. An MFL threshold may be any suitable number, such as one, two, three, four, or more features detectable by the mower 100. In some embodiments, the MFL threshold may be in the single digits, tens, or even hundreds. In the illustrated embodiment, for example, the fourth position 210d may be determined to be a localizable position at night if the MFL is three or less (as shown, three features 218 are within the second feature detection range 216, which may correspond to nighttime).

A heat map based on the feature detection scores may be determined and stored relative to, or in, the navigation map 200. The heat map based on feature detection scores may change over time and with environmental lighting parameter changes.

The navigation map 200 may include a region within the containment zone 204 that represents where the mower 100 may localize under certain conditions. For example, a localization region may be determined based on positions and/or orientations where the feature detection score exceeds the minimum threshold for a particular feature detection range. In the illustrated embodiment, the navigation map 200 includes a localization region 222. The localization region 222 is determined based on the second detection range 216 associated with nighttime or low light. The localization region 222 may represent the area, outside of the exclusion zone 208, where the mower 100 is able to localize when operating at night. In general, each position and/or orientation may have corresponding feature detection score. The feature detection scores may be uniform or non-uniform throughout the localization region 222. For example, the feature detection score may be higher in a position and/or orientation of the mower 100 in which one or more cameras face the building in the exclusion zone 208 and capture a high number of features.

In some embodiments, the size and/or shape of the localization region 222 may change based on changes to the feature detection range 216. The feature detection range 216 may change, for example, due to changes in the minimum threshold or changes in the environmental lighting parameter. In some embodiments, where the environmental lighting parameter is measured, the feature detection range 216 and/or the localization region 222 may change between operation or even during operation (night-to-night or as night progresses), for example, due to different lighting conditions due to moonlight, shadows, and other factors.

The navigation map 200 may include one or more buffer zones and related boundaries. Buffer zones may facilitate directing the mower 100 when vision-based localization may be more limited, such as at night or in low light. Using buffer zones may allow the mower 100 to operate outside in an area outside of the localization region 222 away from other boundaries. In some embodiments, a buffer zone may be adjacent to and inside the boundary of a containment zone. In the illustrated embodiment, the buffer zone 224 is adjacent to and inside of the boundary of the containment zone 204. Although not illustrated, in some embodiments, a boundary of a buffer zone may be defined adjacent to and outside the boundary of an exclusion zone, such as exclusion zone 208. In general, buffer zones along some or all of a zone boundary that is not proximate, adjacent to, or intersecting with the localization region 222.

The mower 100 may be restricted to portions of the containment zone 204 that do not overlap with the exclusion zone 208 and the buffer zone 224, for example, at night or in low light. In some embodiments, at night or in low light, the mower 100 may be allowed to operate only outside the boundary of the exclusion zone 208 and inside the boundary the buffer zone 224. During the day when the mower can localize anywhere in the containment zone, the mower 100 may be allowed to operate only outside the boundary of the exclusion zone 208 and inside the boundary of the containment zone 204.

A buffer distance may be determined and used to position the boundary of the buffer zone outside of the localization region 222. In some embodiments, the boundary of the buffer zone may be spaced from the boundary of the localization region 222 by the buffer distance. In some embodiments, the boundary of the buffer zone may be spaced from the boundary of the containment zone 204 by the buffer distance. The buffer zone 224 may be defined between the buffer zone boundary and the boundary of the containment zone 204. When using a travelling containment zone, such as the travelling containment zone 206, the travelling containment zone may be defined initially to include, or grow to include, areas in the localization region 222 and areas outside of the localization region that do not overlap with the buffer zone 224. In general, the uncertainty area 212 may extend beyond the travelling containment zone 206 but not beyond of the containment zone 204.

The buffer distance may be determined based on a minimum, or nominal, distance between vision-based localizations. In some embodiments, a minimum distance between vision-based localizations may be determined based on predetermined factory setting for the performance of the particular autonomous machine and/or based on the particular work region. For example, the distance between vision-based localizations may be calculated based on wheel encoder data and/or IMU data, which may be described as dead reckoning. In some embodiments, the buffer distance may determined based on a fraction, or percentage, of the minimum distance between vision-based localizations. The buffer distance may be less than the minimum distance between vision-based localizations.

In some embodiments, the buffer distance may also be determined based on the environmental lighting parameter. For example, the buffer distance based on the minimum distance between vision-based localizations may be added to in response to an environmental lighting parameter indicating low light. In general, the buffer distance may be increased in response to an environmental lighting parameter indicating lower light available, for example, based on increased exposure times.

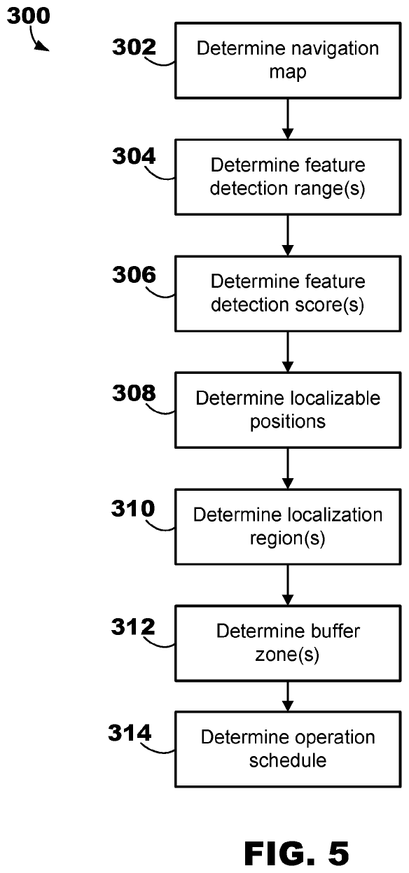

FIG. 5 is a flow diagram showing one example of a method 300 of generating a navigation map including one or more localization regions and one or more buffer zones, for example, used during a training mode of the mower 100. An initial navigation map may be determined 302. The navigation map may be generated based on a 3DPC representing the work region. The navigation map may include one or more containment zone boundaries and optionally one or more exclusion zones defined relative to the 3DPC.

One or more feature detection ranges may be determined 304. A feature detection range may be determined for daytime operation, and another feature detection range may be determined for nighttime operation.

Feature detection ranges may be based on an environmental lighting parameter. Environmental lighting parameters may be based on, for example, nighttime or daytime environmental lighting parameters. Nighttime environmental parameters may be based on a predetermined environmental lighting at night (e.g., worst case or nominal value) or a measured environmental lighting at night in the work region.

One or more feature detection scores for one or more positions and/or orientations may be determined 306. Feature detection scores may be based on a particular feature detection range. In some embodiments, feature detection scores may be determined based on at least a feature detection range corresponding to nighttime operation. In general, a greater feature detection range may result in being able to detect more features in the navigation map.

Localizable positions and/or orientations in the navigation map may be determined 308. Localizable positions and/or orientations may be based on the corresponding feature detection score for each position and/or orientation being above a minimum threshold.

One or more localization regions may be determined 310. Localization regions may be determined based on the localizable positions and/or orientations. In some embodiments, the localization regions may include localizable positions and/or orientations having a feature detection score above the minimum threshold. The navigation map may be updated in response to determining the one or more localization regions.

One or more buffer zones may be determined 312. At least one buffer zone may be adjacent to and inside of a boundary of the containment zone or adjacent to and outside of a boundary of an exclusion zone. In some embodiments, buffer zones may be determined based on the boundaries of the localization regions and a buffer distance, which may be described as an offset. In some embodiments, the buffer zones may be determined based on the boundary of a containment zone or exclusion zone and a buffer distance. The buffer distance may be determined based on a fraction of a minimum distance between localizations, an environmental lighting parameter, or both. The navigation map may be updated in response to determining the one or more buffer zones.

An operation schedule may be determined 314 to cover the work region using the navigation map. A schedule of operation may be determined for the mower automatically, based in user input, or a combination of both. Any suitable technique may be used to determine the operation schedule for the autonomous mower, such as those described in U.S. Provisional Application No. 62/822,342, filed Mar. 22, 2019, which is incorporated by reference.

In some embodiments, the navigation map 200 may be displayed to a user, for example, using the user interface device 119 including a visual representation of the containment zone, any exclusion zones, any localization regions, and any buffer zones. Buffer zone may indicate where the mower cannot mow at night and must be mowed during the day. Areas outside of the localization zone within the containment zone may also indicate where the mower cannot mow at night and must be mowed during the day, for example, depending on the mode of the mower.

In some embodiments, a nighttime schedule for autonomous operation may be determined. The nighttime schedule may include coverage of the localization region and exclude the buffer zone. A daytime schedule for autonomous operation may be determined based on the nighttime schedule. The daytime schedule for autonomous operation may include at least the buffer zone. In general, the coverage of daytime and nighttime schedules may be determined to complement one another to cover the work region within a particular time period. In some embodiments, the coverage of daytime operation and nighttime operation may overlap some areas within the work region, which may help to account for uncertainty in the position and/or orientation of the mower.

In some embodiments, a user may be provided with a notice, for example, on the user interface device 119, in response to determining that the daytime schedule and nighttime schedule for autonomous operation cannot cover the work region within the particular time period. For example, a user may limit the time allowed for mowing during the day such that the buffer zone cannot be covered. The user may be asked, for example, by the user interface device 119, to increase the designated time period to cover the work region or to increase the amount of time available to operate during the daytime.

Localization regions and buffer zones may be used by the mower 100 in different operating modes. In one operating mode, which may be described as a restricted mode, night mode, or nighttime mode, the mower 100 may operate only within the localization region, for example, when the light level does not exceed the light threshold. In another operating mode, which may be described as a dynamic restricted mode, dynamic night mode, or dynamic nighttime mode, the mower 100 may operate within the containment zone including localization regions and outside of the localization regions excluding buffer zones. In another operating mode, which may be described as a dynamic mode, the mower 100 may operate within the containment zone without being restricted by localization regions excluding buffer zones, for example, when the light level exceeds a light threshold indicative of daylight conditions or when no localization region has been determined or is otherwise not available. The mower 100 may use any one or more of these operating modes, which may be factory set, user selected, or otherwise determined by the mower.

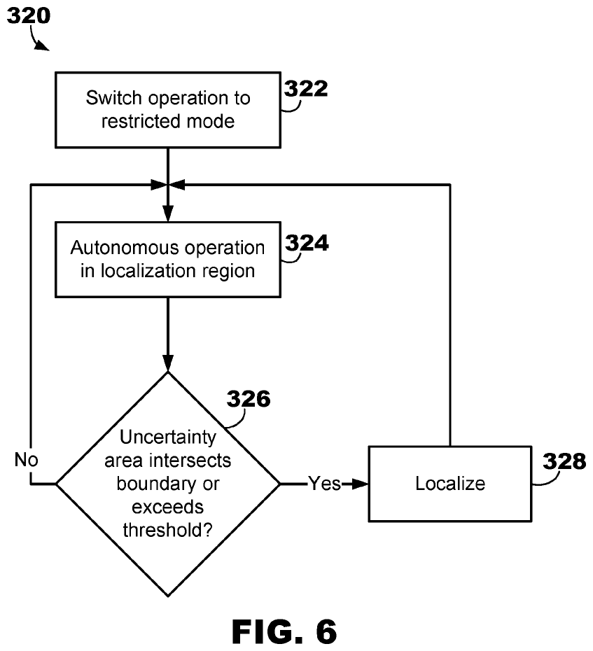

FIG. 6 is a flow diagram showing one example of a method 320 of navigating within localization regions, which may be used in a restricted, night, or nighttime mode for low light conditions. The method 320 may include switching to the restricted mode of operation 322. One or more localization zones, and related boundaries, may be defined within a containment zone in a navigation map, which may be predetermined during the training mode (see FIG. 5). One or more exclusion zones and related boundaries may also be defined within the containment zone in the navigation map. The localization region may be defined based on an environmental lighting parameter. In some embodiments, the environmental lighting parameter may be used to determine feature detection ranges and related feature detection scores for one or more positions and/or orientations in the work region. The feature detection scores may be compared to a minimum threshold to determine positions and/or orientation within the localization region.

In some embodiments, the localization region may be determined based on a predetermined environmental lighting parameter, such as a worst-case lighting parameter at night. In other embodiments, the localization region may be determined based on a measured environmental lighting parameter. The measured environmental lighting parameter may be determined in response to measuring environmental lighting at night in the work region. In some embodiments, the localization region may be updated in response to measuring environmental lighting.

In some embodiments, a traveling containment zone may be used to facilitate coverage of the containment zone. The traveling containment zone may overlap with the localization region and the containment zone outside of the localization region.

The machine may be directed to operate autonomously only in the localization region 324. In some embodiments, a buffer zone may or may not be determined or used.

During operation, the machine may monitor whether an uncertainty area around the machine intersects a zone boundary of the navigation map or exceeds a minimum threshold 326. The machine may initiate a localization 328, for example, in response to determining that the uncertainty area intersects with a zone boundary or exceeds the minimum threshold. The machine may continue to operate autonomously in the localization region 324 after localization. The machine may also continue to operate autonomously in the localization region 324, for example, in response to determining that the uncertainty area does not intersect with a zone boundary and does not exceed the minimum threshold.

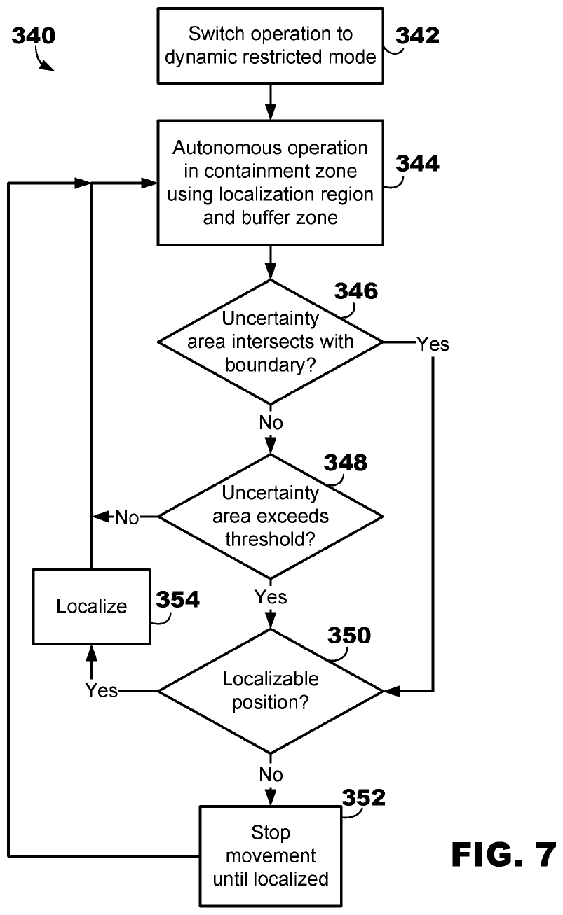

FIG. 7 is a flow diagram showing one example of a method 340 of navigating within a containment zone using localization zones and buffer zones, which may be used in a dynamic restricted, dynamic night, or dynamic nighttime mode for low light conditions. The method 340 may include switching to the dynamic restricted mode of operation 342. One or more localization zones and one or more buffer zones, and related boundaries, may be defined within a containment zone in a navigation map, which may be predetermined during the training mode (see FIG. 5). One or more exclusion zones and related boundaries may also be defined within the containment zone in the navigation map. The localization region may be defined based on an environmental lighting parameter. In some embodiments, the environmental lighting parameter may be used to determine feature detection ranges and related feature detection scores for one or more positions and/or orientations in the work region. The feature detection scores may be compared to a minimum threshold to determine positions and/or orientation within the localization region.

The machine may be directed to operate autonomously within the containment zone 344, for example, within the localization region and outside of the localization region excluding the buffer zone. The machine may also be directed to avoid the one or more buffer zones during autonomous operation.

In some embodiments, the localization region may be determined based on a predetermined environmental lighting parameter, such as a worst-case lighting parameter at night. In other embodiments, the localization region may be determined based on a measured environmental lighting parameter. The measured environmental lighting parameter may be determined in response to measuring environmental lighting at night in the work region. In some embodiments, the localization region may be updated in response to measuring environmental lighting.

In some embodiments, a traveling containment zone may be used to facilitate coverage of the containment zone. The traveling containment zone may overlap with the localization region and the containment zone outside of the localization region excluding the buffer zone.

The machine may monitor whether an uncertainty area intersects with a boundary 346, such as the boundary of the containment zone, a localization zone, or a buffer zone. The machine may determine whether the current position and/or orientation are localizable 350, for example, in response to determining that the uncertainty area intersects with the boundary. The machine may monitor whether the uncertainty area exceeds a threshold 348, for example, in response to determining that the uncertainty area does not intersect with the boundary. In other embodiments (not shown), the machine may continue to operate autonomously in the containment zone 344, for example, in response to determining that the uncertainty area does not intersect with a boundary.

In some embodiments, the determination of whether the machine is in a localizable position and/or orientation 350 may be based on whether the mower is in the localization region. In some embodiments, to determine whether the machine is in a localizable position and/or orientation 350, the machine may compare the current position and/or orientation to the localization region and determine whether the machine is within the localization region. The machine may perform a localization 354, for example, in response to determining that the machine is in a localizable position and/or orientation.

The movement of the machine and/or any of its moving parts (e.g., cutting implement) may be stopped 352, for example, in response to determining that the current position and/or orientation of the machine is not in a localizable position. The stoppage of moving parts such as cutting implements can help conserve power as well act as a safety measure. The machine or one or more of its moving parts may be stopped until the machine is able to localize at the current position. It will be understood that stopping the machine in this context is meant to convey that the machine does not necessarily continue ground traversal, e.g., forward or reverse motion with or without steering, but may still rotate in-place in order to attempt to re-acquire its position and/or orientation. The machine may take various actions while stopped, such as making movements that do not significantly change location but may help in re-acquisition of position and/or orientation, e.g., rocking back and forth. In another embodiment, depending on where the machine is, the machine may be able to travel a short distance away from containment boundaries in order to get to a location update.

In one example, the machine may repeatedly attempt vision-based localization until the machine is able to localize, which may involve rotation of the machine and/or a sensor of the machine about a vertical axis while acquiring vision-based data. In some embodiments, the mower may increase one or more of exposure time, gain, and aperture size, which may facilitate vision-based localization in low light conditions. The machine may additionally or alternatively activate a light source (e.g., visible, infrared) that illuminates a view of the vision-based senor in an attempt to obtain vision-based localization in low light conditions. In another embodiment, the machine may utilize a second vision-based sensor (e.g., alternate camera) instead of or in addition to the vision-based sensor used for the initial localization. The second vision-based sensor may be co-located with the first vision-based sensor but of a different type (e.g., infrared versus visible spectrum) The second vision-based sensor may be separately located from the first vision-based sensor and be of a same or different type. In another example, the machine may attempt non-vision-based localization using at least one non-vision-based sensor, such as a GPS. For example, a GPS receiver may obtain a more accurate geolocation accuracy when not moving for some amount of time (e.g., “soaking” the GPS), thus allowing the machine to localize enough to move again. In some embodiments, the machine may attempt non-vision-based localization in response to one or more unsuccessful attempts to use vision-based localization. Upon successful localization, the machine may continue to operate autonomously in the containment zone 344. In one embodiment, after re-acquisition the machine may move towards areas of known good localization (e.g., an area with localization certainty below a threshold) to avoid further instances of localization loss.

In an alternate embodiment, instead of stopping ground traversal of the machine in response to determining that the current position and/or orientation of the machine is not in a localizable position, the machine may be configured to move to a second position to re-acquire localization. In one embodiment, the machine may backtrack, e.g., using signals from an inertial measurement unit or wheel encoder to retrace the path just traveled before localization was lost. This may still involve stopping of cutting implements and other moving parts as described above. The backtracking could occur incrementally, e.g., x-number of tries, each involving backing up y-feet. If this does not result in re-acquisition after the x-number of tries, then ground traversal could be stopped and re-acquisition at rest as described above may be attempted. In another embodiment, the machine may travel away from containment boundaries in an attempt to re-acquire localization.

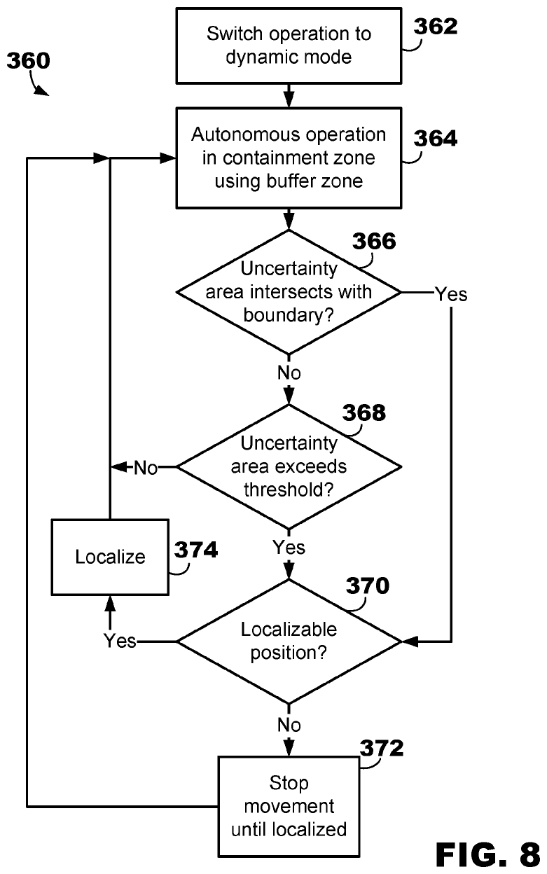

FIG. 8 is a flow diagram showing one example of a method 360 of navigating within a containment zone using buffer zones, which may be used in a dynamic mode for low light conditions. Method 360 may be similar to method 340 except that method 360 may not determine a localization region. The method 360 may include switching to the dynamic mode of operation 362. One or more buffer zones, and related boundaries, may be defined within a containment zones in a navigation map 362, for example, during a training mode (see FIG. 5) based on the boundary of a containment zone or an exclusion zone and a buffer distance. One or more exclusion zones and related boundaries may also be defined within the containment zone in the navigation map.

The machine may be directed to operate autonomously within the containment zone 364, for example, excluding the buffer zone. The machine may also be directed to avoid the one or more buffer zones during autonomous operation.

In some embodiments, a traveling containment zone may be used to facilitate coverage of the containment zone. The traveling containment zone may overlap with the containment zone excluding the buffer zone.

The machine may monitor whether an uncertainty area intersects with a boundary 366, such as the boundary of the containment zone or a buffer zone. The machine may determine whether the current position and/or orientation are localizable 370, for example, in response to determining that the uncertainty area intersects with the boundary. The machine may monitor whether the uncertainty area exceeds a threshold 368, for example, in response to determining that the uncertainty area does not intersect with the boundary. In other embodiments (not shown), the machine may continue to operate autonomously in the containment zone 364, for example, in response to determining that the uncertainty area does not intersect with a boundary.

In some embodiments, the determination of whether the machine is in a localizable position and/or orientation 370 may be based on whether the mower is in the localization region. In some embodiments, to determine whether the machine is in a localizable position and/or orientation 370, the machine may attempt to perform vision-based localization. In some embodiments, an environmental lighting parameter may be used to determine whether the current position and/or orientation is localizable. The environmental lighting parameter may be used to determine a feature detection range and a related feature detection score in the current position and/or orientation. The feature detection score may be compared to a minimum threshold to determine whether the current position and/or orientation is localizable. The machine may perform a localization 374, for example, in response to determining that the machine is in a localizable position and/or orientation.

The movement of the machine may be stopped 372, for example, in response to determining that the current position and/or orientation of the machine is not in a localizable position. The machine may be stopped until the machine is able to localize at the current position. The machine may take various actions while stopped. In one example, the machine may repeatedly attempt vision-based localization until the machine is able to localize. In some embodiments, the mower may increase one or more of exposure time, gain, and aperture size, which may facilitate vision-based localization in low light conditions. In another example, the machine may attempt non-vision-based localization using at least one non-vision-based sensor, such as a GPS. In some embodiments, the machine may attempt non-vision-based localization in response to one or more unsuccessful attempts to use vision-based localization. Upon successful localization, the machine may continue to operate autonomously in the containment zone 364.

In some embodiments, a method (not shown) similar to method 360 may be used for navigation during the day. For example, the buffer zone may or may not be determine or used when operating during the day.

### ILLUSTRATIVE EMBODIMENTS

While the present disclosure is not so limited, an appreciation of various aspects of the disclosure will be gained through a discussion of the specific examples and illustrative embodiments provided below. Various modifications of the illustrative embodiments, as well as additional embodiments of the disclosure, will become apparent herein.

Embodiment A1 is method of training an autonomous machine in a work region for navigation in various lighting conditions. The method comprises: determining data representing a navigation map of the work region, the navigation map including a containment zone; determining a feature detection range based on an environmental lighting parameter; determining a feature detection score for each of one or more positions in the containment zone based on the feature detection range; determining one or more localizable positions in the containment zone based on the corresponding feature detection scores; and updating the navigation map to include a localization region within the containment zone based on the one or more localizable positions and storing data representing the updated navigation map.

Embodiment A2 includes the method according to embodiment A1, further comprising determining the environmental lighting parameter based on a nighttime environmental lighting parameter. Embodiment A3 includes the method according to embodiment A2, wherein the nighttime environmental lighting parameter corresponds to a predetermined environmental lighting at night. Embodiment A4 includes the method according to embodiment A2, wherein the nighttime environmental parameter corresponds to a measured environmental lighting at night in the work region.

Embodiment A5 includes the method according to any of embodiments A2 to A4, further comprising determining another feature detection range based on a daytime environmental lighting parameter corresponding to a time of day between dawn and twilight. Embodiment A6 includes the method according to any one of the preceding A embodiments, wherein determining the one or more localizable positions comprises comparing the corresponding feature detection scores to a minimum threshold.

Embodiment A7 includes the method according to any one of the preceding A embodiments, further comprising determining one or more buffer zones, wherein at least one buffer zone is adjacent to and inside of a boundary of the containment zone or adjacent to and outside of a boundary of an exclusion zone. Embodiment A8 includes the method according to embodiment A7, wherein determining one or more buffer zones comprises determining a buffer distance based on a minimum distance between localizations, the environmental lighting parameter, or both.

Embodiment A9 includes the method according to embodiment A8, wherein determining a buffer distance based on a minimum distance between localizations comprises determining the buffer distance as a fraction of the minimum distance between localizations. Embodiment A10 includes the method according to any one of the preceding A embodiments, further comprising displaying on a user interface the updated navigation map and an indication of nighttime autonomous operation relative to the localization region.

Embodiment A11 includes the method according to any one of the preceding A embodiments, further comprising determining a daytime schedule for autonomous operation based on a nighttime schedule for autonomous operation relative to the localization region. Embodiment A12 includes the method according to embodiment A11, wherein the daytime schedule and the nighttime schedule for autonomous operation are determined to complement one another to cover the work region within a particular time period.

Embodiment A13 includes the method according to embodiment A12, further comprising providing a notice to a user on a user interface in response to determining that the daytime schedule and nighttime schedule for autonomous operation cannot cover the work region within the particular time period. Embodiment A14 includes the method according to any one of the preceding A embodiments, wherein determining data representing the navigation map comprises determining a three-dimensional point cloud (3DPC) representing the work region.

Embodiment B1 is a method of navigation in various lighting conditions for an autonomous machine in a work region. The method comprises: determining a localization region in a navigation map of the work region, wherein the localization region is defined based on an environmental lighting parameter; determining an operating mode based on the environmental lighting parameter; and directing the machine to operate autonomously within the localization region based on the operating mode.

Embodiment B2 includes the method according to embodiment B1, further comprising determining one or more buffer zones, wherein at least one buffer zone is adjacent to and inside of a containment zone or adjacent to and outside of an exclusion zone, wherein directing the machine to operate autonomously comprises directing the machine to avoid the one or more buffer zones during nighttime autonomous operation.

Embodiment B3 includes the method according to embodiment B1 or B2, further comprising localizing the machine during autonomous operation using at least one vision-based sensor. Embodiment B3 includes the method according to any one of the preceding B embodiments, further comprising: determining whether the machine is able to localize at a current position; and in response to determining that the machine is unable to localize at the current position, stopping autonomous movement of the machine until the machine is able to localize at the current position.

Embodiment B4 includes the method according to embodiment B3, further comprising directing the machine to operate autonomously within a containment zone outside of the localization region. Embodiment B5 includes the method according to any one of embodiments B4 to B6, further comprising, in response to determining that the machine is unable to localize at the current position, localizing the machine using at least one non-vision-based sensor.

Embodiment B6 includes the method according to any one of the preceding B embodiments, further comprising: determining an uncertainty area around the machine; comparing the uncertainty area to an uncertainty area threshold; and localizing the machine in response to determining that the uncertainty area exceeds the uncertainty area threshold. Embodiment B7 includes the method according to embodiment B6, further comprising: determining whether the uncertainty area around the machine intersects with a boundary of a zone; stopping autonomous movement of the machine in response to determining that the uncertainty area around the machine intersects with a boundary of a zone; and localizing the machine in response to stopping autonomous movement of the machine.

Embodiment B8 includes the method according to any one of the preceding B embodiments, further comprising updating the localization region in response measuring environmental lighting at night in the work region. Embodiment B9 includes the method according to embodiment B8, wherein directing the machine to operate autonomously within the localization region comprises directing the machine to operate autonomously within a travelling containment zone within the updated localization region.

Embodiment C1 is a method of navigation in various lighting conditions for an autonomous machine in a work region. The method comprises: directing the machine to operate autonomously within a containment zone defined in a navigation map of the work region; determining whether vision-based localization is available at a position of the machine based on at least an environmental lighting parameter; and in response to determining that vision-based localization is not available at the position of the machine, stopping autonomous movement of the machine until the machine is able to localize at the current position.

Embodiment C2 includes the method according to example C1, further comprising determining one or more buffer zones, wherein at least one buffer zone is adjacent to and inside of the containment zone or adjacent to and outside of an exclusion zone, wherein directing the machine to operate autonomously comprises directing the machine to avoid the one or more buffer zones during nighttime autonomous operation.

Embodiment C3 includes the method according to example C1 or C2, further comprising: determining an uncertainty area around the machine; comparing the uncertainty area to an uncertainty area threshold; and localizing the machine in response to determining that the uncertainty area exceeds the uncertainty area threshold. Embodiment C4 includes the method according to example C3, further comprising: determining whether the uncertainty area around the machine intersects with a boundary of a zone; stopping autonomous movement of the machine in response to determining that the uncertainty area around the machine intersects with a boundary of a zone; and localizing the machine in response to stopping autonomous movement of the machine.

Embodiment D1 includes an autonomous machine comprising: a housing coupled to a maintenance implement; a propulsion system comprising a propulsion controller operably coupled to at least one motor; at least one camera adapted to record images in one or more environmental lighting conditions; and a controller operably coupled to the at least one camera and the propulsion controller, the controller adapted to perform a method according to any of the A, B, and C examples.

Embodiment E1 includes a method of navigation in various lighting conditions for an autonomous machine in a work region. The method comprises determining a localization region in a navigation map of the work region, wherein the localization region is defined based on an environmental lighting parameter; determining an operating mode based on the environmental lighting parameter, the operating mode defining whether the autonomous machine is allowed to operate outside of the localization region; and directing the autonomous machine to operate autonomously within the work region based on the operating mode.

Embodiment E2 includes the method according to embodiment E1, wherein the operating mode comprises a nighttime mode, the method further comprising determining one or more buffer zones, wherein at least one buffer zone is adjacent to and inside of a containment zone or adjacent to and outside of an exclusion zone, wherein directing the autonomous machine to operate autonomously comprises directing the autonomous machine to avoid the one or more buffer zones during the nighttime mode.

Embodiment E3 includes the method according to any of embodiments E1 or E2, further comprising: determining whether the autonomous machine is able to localize at a current position; and in response to determining that the autonomous machine is unable to localize at the current position, moving the machine to a second position to re-acquire localization. Embodiment E4 includes the method according to embodiment E3, wherein moving the machine to the second position comprises moving away from a boundary.

Embodiment E5 includes the method according to embodiment E3, wherein moving the machine to the second position comprises back tracking. Embodiment E6 includes the method according to any of embodiments E1 or E2, further comprising: determining whether the autonomous machine is able to localize at a current position; and in response to determining that the autonomous machine is unable to localize at the current position, stopping at least one of autonomous ground traversal of the autonomous machine and a moving part of the autonomous machine until the autonomous machine is able to localize at the current position using a vision-based sensor.

Embodiment E7 includes the method according to embodiment E6, further comprising, in response to localizing the current position, directing the autonomous machine to operate autonomously within a region having known good localization. Embodiment E8 includes the method according to embodiments E3 or E4, further comprising, in response to determining that the autonomous machine is unable to localize at the current position, using the vision-based sensor, localizing the autonomous machine using at least one non-vision-based sensor. Embodiment E9 includes the method according to embodiment E8, wherein the at least one non-vision-based sensor comprises a GPS sensor, and wherein the ground traversal of the autonomous machine stops for a period of time that allows the GPS sensor to obtain a more accurate geolocation reading.

Embodiment E10 includes the method according to embodiments E3 or E4, further comprising, in response to determining that the autonomous machine is unable to localize at the current position, activating a light source that illuminates a view of the vision-based sensor. Embodiment E11 includes the method according to embodiments E3 or E4, further comprising, in response to determining that the autonomous machine is unable to localize at the current position, localizing the current position using a second-vision based sensor.

Embodiment E12 includes the method according to embodiment E1, further comprising: determining an uncertainty area around the autonomous machine; comparing the uncertainty area to an uncertainty area threshold; and localizing the autonomous machine in response to determining that the uncertainty area exceeds the uncertainty area threshold. Embodiment E13 includes the method according to embodiment E12, further comprising: determining whether the uncertainty area around the autonomous machine intersects with a boundary of a zone; stopping autonomous movement of the autonomous machine or a moving part of the autonomous machine in response to determining that the uncertainty area around the autonomous machine intersects with a boundary of a zone; and localizing the autonomous machine in response to stopping autonomous movement of the autonomous machine.

Embodiment E14 includes the method according to embodiment E1, further comprising updating the localization region in response measuring environmental lighting at night in the work region. Embodiment E15 includes the method according to embodiment E14, wherein directing the autonomous machine to operate autonomously within the localization region comprises directing the autonomous machine to operate autonomously within a travelling containment zone within the updated localization region.

Embodiment E16 includes the method of embodiment E1, further comprising: determining a containment zone within the navigation map of the work region; determining a feature detection range based on the environmental lighting parameter; determining a feature detection score for each of one or more positions in the containment zone based on the feature detection range; determining one or more localizable positions in the containment zone based on the corresponding feature detection scores; and updating the navigation map to include the localization region within the containment zone based on the one or more localizable positions and storing data representing the updated navigation map.

Embodiment F1 is a an autonomous machine comprising: a housing coupled to a maintenance implement; a propulsion system comprising a propulsion controller operably coupled to at least one motor; at least one vision-based sensor operable to record images in an environmental lighting condition; and a controller operably coupled to the at least one vision-based sensor and the propulsion controller, the controller operable to perform the method of any of claims E1-E16.

Thus, various embodiments of autonomous machine navigation in various lighting environments are disclosed. Although reference is made herein to the accompanying set of drawings that form part of this disclosure, one of at least ordinary skill in the art will appreciate that various adaptations and modifications of the embodiments described herein are within, or do not depart from, the scope of this disclosure. For example, aspects of the embodiments described herein may be combined in a variety of ways with each other. Therefore, it is to be understood that, within the scope of the appended claims, the claimed invention may be practiced other than as explicitly described herein.

All references and publications cited herein are expressly incorporated herein by reference in their entirety for all purposes, except to the extent any aspect directly contradicts this disclosure.

All scientific and technical terms used herein have meanings commonly used in the art unless otherwise specified. The definitions provided herein are to facilitate understanding of certain terms used frequently herein and are not meant to limit the scope of the present disclosure.

The recitation of numerical ranges by endpoints includes all numbers subsumed within that range (e.g. 1 to 5 includes 1, 1.5, 2, 2.75, 3, 3.80, 4, and 5) and any range within that range.

The terms “coupled” or “connected” refer to elements being attached to each other either directly (in direct contact with each other) or indirectly (having one or more elements between and attaching the two elements). Either term may be modified by “operatively” and “operably,” which may be used interchangeably, to describe that the coupling or connection is configured to allow the components to interact to carry out functionality.

As used herein, the term “configured to” may be used interchangeably with the terms “adapted to” or “structured to” unless the content of this disclosure clearly dictates otherwise.

1. A method of navigation in various lighting conditions for an autonomous machine in a work region, the method comprising:
determining a localization region in a navigation map of the work region, wherein the localization region is defined based on a feature detection range of the autonomous machine that is determined based on an environmental lighting parameter indicative of a light level of a surrounding environment;
determining an operating mode based on the environmental lighting parameter, the operating mode defining whether the autonomous machine is allowed to operate outside of the localization region; and
directing the autonomous machine to operate autonomously within the work region based on the operating mode.

2. The method according to claim 1, wherein the operating mode comprises a nighttime mode, the method further comprising determining one or more buffer zones, wherein at least one buffer zone is adjacent to and inside of a containment zone or adjacent to and outside of an exclusion zone, wherein directing the autonomous machine to operate autonomously comprises directing the autonomous machine to avoid the one or more buffer zones during the nighttime mode.

3. The method according to claim 1, further comprising:
determining whether the autonomous machine is able to localize at a current position; and
in response to determining that the autonomous machine is unable to localize at the current position, moving the machine to a second position to re-acquire localization.

4. The method according to claim 3, wherein moving the machine to the second position comprises moving away from a boundary.

5. The method according to claim 3, wherein moving the machine to the second position comprises back tracking.

6. The method according to claim 1, further comprising:
determining whether the autonomous machine is able to localize at a current position; and
in response to determining that the autonomous machine is unable to localize at the current position, stopping at least one of autonomous ground traversal of the autonomous machine and a moving part of the autonomous machine until the autonomous machine is able to localize at the current position using a vision-based sensor.

7. The method according to claim 6, further comprising, in response to localizing the current position, directing the autonomous machine to operate autonomously within a region having known good localization.

8. The method according to claim 6, further comprising, in response to determining that the autonomous machine is unable to localize at the current position using the vision-based sensor, localizing the autonomous machine using at least one non-vision-based sensor.

9. The method according to claim 8, wherein the at least one non-vision-based sensor comprises a GPS sensor, and wherein the ground traversal of the autonomous machine stops for a period of time that allows the GPS sensor to obtain a more accurate geolocation reading.

10. The method according to claim 6, further comprising, in response to determining that the autonomous machine is unable to localize at the current position, activating a light source that illuminates a view of the vision-based sensor.

11. The method according to claim 6, further comprising, in response to determining that the autonomous machine is unable to localize at the current position, localizing the current position using a second-vision based sensor.

12. The method according to claim 1, further comprising:
determining an uncertainty area around the autonomous machine;
comparing the uncertainty area to an uncertainty area threshold; and
localizing the autonomous machine in response to determining that the uncertainty area exceeds the uncertainty area threshold.

13. The method according to claim 12, further comprising:
determining whether the uncertainty area around the autonomous machine intersects with a boundary of a zone;
stopping autonomous movement of the autonomous machine or a moving part of the autonomous machine in response to determining that the uncertainty area around the autonomous machine intersects with a boundary of a zone; and
localizing the autonomous machine in response to stopping autonomous movement of the autonomous machine.

14. The method according to claim 1, further comprising updating the localization region in response to measuring environmental lighting at night in the work region.

15. The method according to claim 14, wherein directing the autonomous machine to operate autonomously within the localization region comprises directing the autonomous machine to operate autonomously within a travelling containment zone within the updated localization region.

16. The method of claim 1, further comprising:
determining a containment zone within the navigation map of the work region;
determining a feature detection score for each of one or more positions in the containment zone based on the feature detection range;
determining one or more localizable positions in the containment zone based on the corresponding feature detection scores; and
updating the navigation map to include the localization region within the containment zone based on the one or more localizable positions and storing data representing the updated navigation map.

17. An autonomous machine comprising:
a housing coupled to a maintenance implement;
a propulsion system comprising a propulsion controller operably coupled to at least one motor;
at least one vision-based sensor operable to record images in an environmental lighting condition; and
a controller operably coupled to the at least one vision-based sensor and the propulsion controller, the controller operable to perform:
determining a localization region in a navigation map of a work region, wherein the localization region is defined based on a feature detection range of the autonomous machine that is determined based on an environmental lighting parameter indicative of a light level of the environmental lighting condition;
determining an operating mode based on the environmental lighting parameter, the operating mode defining whether the autonomous machine is allowed to operate outside of the localization region; and
directing the autonomous machine to operate autonomously within the work region based on the operating mode.

18. The autonomous machine according to claim 17, wherein the operating mode comprises a nighttime mode, wherein the controller is further operable to perform determining one or more buffer zones, wherein at least one buffer zone is adjacent to and inside of a containment zone or adjacent to and outside of an exclusion zone, wherein directing the autonomous machine to operate autonomously comprises directing the autonomous machine to avoid the one or more buffer zones during the nighttime mode.

19-26. (canceled)

27. The autonomous machine according to claim 17, wherein the controller is further operable to perform updating the localization region in response measuring environmental lighting at night in the work region.

28. The autonomous machine according to claim 27, wherein directing the autonomous machine to operate autonomously within the localization region comprises directing the autonomous machine to operate autonomously within a travelling containment zone within the updated localization region.

29. The autonomous machine of claim 17, wherein the controller is further operable to perform:
determining a containment zone within the navigation map of the work region;
determining a feature detection range based on the environmental lighting parameter;
determining a feature detection score for each of one or more positions in the containment zone based on the feature detection range;
determining one or more localizable positions in the containment zone based on the corresponding feature detection scores; and
updating the navigation map to include the localization region within the containment zone based on the one or more localizable positions and storing data representing the updated navigation map.

30. A method of navigation in various lighting conditions for an autonomous machine in a work region, the method comprising:
determining a localization region in a navigation map of the work region, wherein the localization region is defined based on an environmental lighting parameter measured at night in the work region;
determining an operating mode based on the environmental lighting parameter, the operating mode defining whether the autonomous machine is allowed to operate outside of the localization region; and
directing the autonomous machine to operate autonomously within the work region based on the operating mode.
